(19) United States
(12) Patent Application Publication
(10) Pub. No.: US 2016/0301689 A1
(43) Pub. Date: Oct. 13, 2016

(54) DIGITAL IDENTITY ENROLLMENT SYSTEM

(71) Applicant: Honeywell International Inc., Morristown, NJ (US)

(72) Inventors: Sanjay Roy, Plymouth, MN (US); Bryan Jones, Muswellbrook (AU); Frank Lin, Oatlands (AU); Datta Godbole, Plymouth, MN (US); Himanshu Khurana, Plymouth, MN (US)

(21) Appl. No.: 14/683,803

(22) Filed: Apr. 10, 2015

(51) Int. Cl. H04L 29/06

(52) U.S. Cl. CPC H04L 63/0853; H04L 63/0876

(57) ABSTRACT

Digital identity enrollment systems are described herein. One device includes a memory, and a processor configured to execute executable instructions stored in the memory to receive information verifying a user's physical identity, generate a digital identity and a physical badge corresponding to the physical identity of the user, and send the digital identity to a mobile device of the user.

### TECHNICAL FIELD

The present disclosure relates to digital identity enrollment systems.

### BACKGROUND

Physical access control systems are designed to provide access to areas of a building for individuals who are authorized to access such areas, and deny access to those areas of the building to individuals who are not authorized to access such areas. For example, certain individuals may be authorized to access a secure area of a building, whereas other individuals may not be allowed to access the secure area.

Current approaches to physical access control systems may rely on users (e.g., employees) carrying physical access cards (e.g., physical badge) to gain entry to areas of a building. For example, a user can use a physical access card at a security door to gain entry to an area of a building. However, forcing a user to carry a physical access card can be cumbersome. Further, a user can be locked out of an area if the user forgets to carry the physical access card. Additionally, an unauthorized user may gain access to an unauthorized area because the access control system can't verify the physical identity of the user carrying the physical access card.

### BRIEF DESCRIPTION OF THE DRAWINGS

FIG. 1 is a flow chart of a method for operating a digital identity enrollment system, in accordance with one or more embodiments of the present disclosure.

FIG. 2 illustrates a system for digital identity enrollment, in accordance with one or more embodiments of the present disclosure.

FIG. 3 is a schematic block diagram of a management platform for use with a digital identity enrollment system, in accordance with one or more embodiments of the present disclosure.

### DETAILED DESCRIPTION

Digital identity enrollment systems are described herein. For example, one or more embodiments include a memory, and a processor configured to execute executable instructions stored in the memory to receive information verifying a user's physical identity, generate a digital identity and a physical badge corresponding to the physical identity of the user, and send the digital identity to a mobile device of the user.

Using a digital identity enrollment system, in accordance with the present disclosure, may lead to simple and efficient access authorization for users through a single interface (e.g., a mobile device). As a result, users (e.g., employees) may no longer need to carry physical access cards to gain entry to areas in which they have been granted access.

Further, digital identity enrollment systems in accordance with the present disclosure may be more secure than previous approaches. For instance, a user may guard their mobile device more closely than a physical access card.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

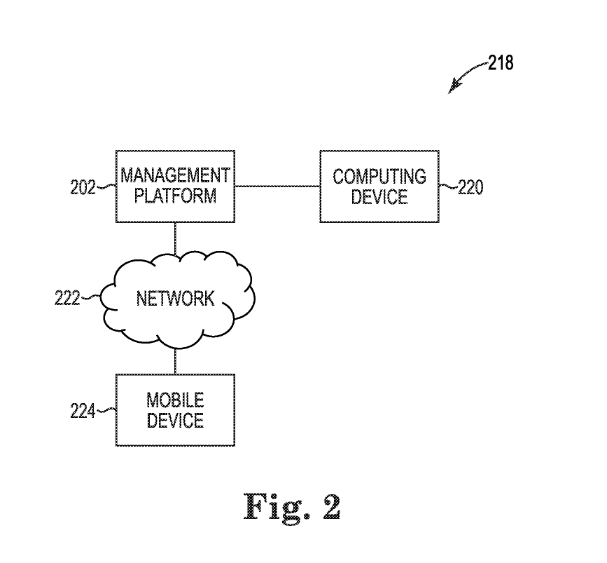

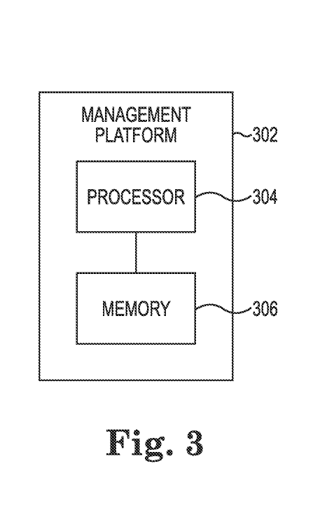

The figures herein follow a numbering convention in which the first digit or digits correspond to the drawing figure number and the remaining digits identify an element or component in the drawing. Similar elements or components between different figures may be identified by the use of similar digits. For example, 202 may reference element “02” in FIG. 2, and a similar element may be reference as 302 in FIG. 3.

As used herein, “a” or “a number of” something can refer to one or more such things. For example, “a number of mobile devices” can refer to one or more mobile devices.

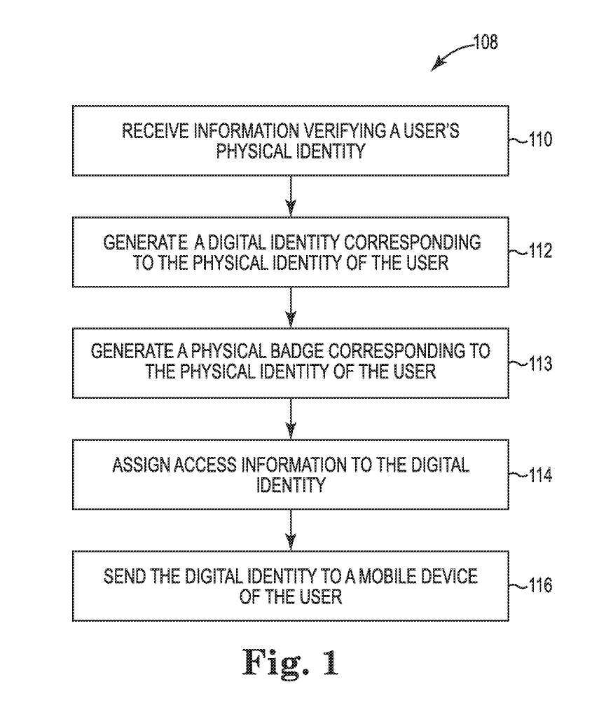

FIG. 1 is a flow chart of a method 108 for operating a digital identity enrollment system, in accordance with one or more embodiments of the present disclosure. Method 108 can be performed by, for example, management platforms 202 and 302 described in connection with FIGS. 2 and 3, respectively.

For instance, the management platform can use method 108 to generate a digital identity and a physical badge for use in a building that includes a physical access control system. A physical access control system, as used herein, can include a system that manages building access (e.g., access to different areas of the building) for a number of users. As used herein, a user can include a person (e.g., employee, guest, or visitor) having a mobile device.

A physical badge, as used herein, can include a physical access card that stores information of a user. For instance, the physical badge can store access information to be used by a user to gain access to areas of a building the card has authorization to access. For example, the physical badge can use radio frequency identification (RFID) or near-field communication (NFC), among other means of wireless communication, to gain access to different areas of a building.

The management platform can be a part of a building management system. For example, the building management system can include the management platform, the physical access control system, as well as various other building controls.

Although described as a physical access control system for a building, embodiments of the present disclosure are not so limited. For example, the physical access control system can be a control system used for use at an outdoor area, or other type of facility where access to different areas needs to be controlled.

The physical access control system can be a control system for multiple buildings and/or facilities. For example, a digital identity can be used to access areas in multiple different buildings and/or facilities.

At block 110, the method 108 can include receiving information verifying a user's physical identity. For instance, the management platform can receive physical identity information about a user who is to receive a physical badge and/or digital identity on their mobile device.

Physical identity information can include information that describes a user's physical characteristics. For example, physical identity information can include a user's name, age, physical characteristics such as height, weight, eye color and/or hair color, date of birth, or a picture of the user.

At block 112, the method 108 can include generating a digital identity corresponding to the physical identity of the user. For instance, the management platform can generate a digital identity utilizing the physical identity information of the user. The digital identity is unique to the mobile device of the user (e.g., one digital identity per mobile device of the user). For example, a user can receive a digital identity on their mobile device, as will be further described herein.

Although described as generating a digital identity for a single user, embodiments of the present disclosure are not so limited. For example, method 208 can include generating a number of digital identities, wherein each respective digital identity corresponds to a different one of the number of users' physical identities.

Generating a digital identity for use on a mobile device for building access in accordance with the present disclosure can provide improved security over physical access cards. For example, mobile devices can offer additional security features to access the mobile device, such as utilizing a personal identification number (PIN), password, fingerprint scanning, facial recognition, and/or corporate network infrastructure to ensure the identity of the user who is using the mobile device to access areas of the building.

Generating a number of digital identities can include assigning the number of users' physical identification information to the number of digital identities. A user's physical identification information received from a computing device, as will be further described herein, can be assigned to the user's corresponding digital identity.

In some embodiments, the digital identity can be a permanent digital identity. A permanent digital identity can be a digital identity that does not expire. For example, a permanent digital identity can be sent to the mobile device of a user who is an employee that works in a building that includes a physical access control system. The employee can utilize the permanent digital identity until the employee is no longer employed at the building with the physical access control system.

In some embodiments, the digital identity can be a temporary digital identity. A temporary digital identity can be a digital identity that expires after a set period of time. For example, a temporary digital identity can be sent to the mobile device of a user who is a visitor or guest at a building that includes a physical access control system. After the set period of time, the visitor/guest's temporary digital identity can expire, and the visitor/guest can lose access to the building.

The digital identity (or number of digital identities) can be shared with a building management system. The building management system can be used (e.g., by a single user) to manage (e.g., monitor and/or control) the building. For instance, the user (e.g., building manager and/or building technician) can monitor information relating to a number of digital identities assigned to a number of user's mobile devices in order to track who is accessing what areas of the building and when access is occurring.

At block 113, the method 108 can include generating a physical badge corresponding to the physical identity of the user. For instance, the management platform can generate a physical badge utilizing the physical identity information of the user. The physical badge is unique to the user (e.g., one physical badge per user). For example, the user can receive a physical badge in addition to the digital identity received at the user's mobile device, as will be further described herein.

At block 114, the method 108 can include assigning access information to the digital identity. Access information assigned to a digital identity can vary from one user to another. Access information, as used herein, can include information describing a user's ability to access different areas of a building that includes a physical access control system. For example, a supervisory employee may be able to access more areas of a building than a lower level employee.

In some embodiments, the access information can be preconfigured access information. Preconfigured access information can include utilizing preconfigured access levels to grant different levels of access to different digital identities. For example, lower level employees can be given an access level that grants an employee access to lower security areas of a building, whereas higher level employees can be given an access level that allows those higher level employees access to areas with higher security restrictions. As an additional example, access levels can be preconfigured based on the position the employee holds (e.g., a secretary can receive a different access level than a building technician).

In some embodiments, the access information can be customized access information. Customized access information can include access information that is customized for an individual user. For example, a user can receive access to areas A, B, C, and E, but not area D. As another example, a user can receive access to areas of a building that do not fall within a preconfigured access level.

In some embodiments, the physical badge can include access information. For instance, the physical badge can include pre-configured access information or customized access information. For example, the user's physical badge can include the same access information included in the user's digital identity (e.g., on user's the mobile device).

Although described as generating a single physical badge, embodiments of the present disclosure are not so limited. For example, the management platform can generate a number of physical badges for each respective user. For instance, the management platform can generate a physical badge corresponding to each respective user's physical identity.

At block 116, the method 108 can include the management platform sending the digital identity to a mobile device of the user. Once the digital identity has been generated, the digital identity is sent to a user's mobile device. As used herein, a mobile device can be a phone (e.g., a smart phone), a tablet, a personal digital assistant (PDA), and/or a wrist-worn device, among other types of devices that may be carried and/or worn by a user.

Although described as sending a single digital identity to a mobile device of a single user, embodiments of the present disclosure are not so limited. For example, the management platform can send a number of digital identities to a mobile device of each respective user. For instance, the management platform can send the digital identity corresponding to each respective user's physical identity to the mobile device of that respective user.

Sending the digital identities to the mobile device of each respective user can include sending a request to download an identity application to the mobile device of each respective user. An identity application can include an application installed on the mobile device of a user. The identity application can receive the digital identity and be used as an interface for the user to the digital identity. For example, a user can access (e.g., view) information relating to the digital identity assigned to that user.

The digital identities are sent to the respective identity applications on the mobile devices of the respective users. For example, a lower level employee can receive, by the identity application on the lower level employee's mobile device, the lower level employee's digital identity. Further, a higher level employee can receive, by the identity application on the higher level employee's mobile device, the higher level employee's digital identity.

Each respective digital identity is unique to its respective mobile device. For example, a digital identity generated for a lower level employee corresponds to the mobile device of the lower level employee.

Although not shown in FIG. 1, the method 108 can further include modifying a digital identity. For instance, physical identification information of a user (e.g., name, age, physical characteristics such as height, weight, eye color and/or hair color, date of birth, or picture) may change over time. For example, an employee's name and/or picture may need to be updated. The physical identification information, once updated, can be received by the management platform and the corresponding digital identity updated accordingly.

The method 108 can further include sending the modified digital identity to the mobile device of the respective user. After the user's digital identity is updated according to the updated physical identity information, the updated digital identity can be sent to the mobile device of the respective user.

Although not shown in FIG. 1, the method 108 can include revoking a digital identity. A digital identity may need to be revoked. For example, an employee with a permanent digital identity who has resigned may need to have the corresponding digital identity revoked. As another example, a guest or visitor may have a temporary digital identity that expires after a predetermined period of time. The temporary digital identity is revoked after the predetermined time period has expired.

A digital identity can be revoked by the management platform. For example, the management platform can send a request to the identity application located on a user's mobile device to revoke (e.g., disable or delete) the digital identity located on that user's mobile device.

FIG. 2 illustrates a system 218 for digital identity enrollment, in accordance with one or more embodiments of the present disclosure. As shown in FIG. 2, the system includes a computing device 220, a management platform 202, a network 222, and a mobile device 224.

Computing device 220 can be an input device that receives information verifying a user's physical identity and sends that physical identity information to the management platform 202. For example, computing device 220 can receive a user's physical identity information that describes a user's physical characteristics that may include a user's name, age, physical characteristics such as height, weight, eye color and/or hair color, date of birth, or a picture of the user. As used herein, computing device 220 can be, for example, a laptop computer, a desktop computer, or a mobile device (e.g., a smart phone, tablet, personal digital assistant, etc.), among other types of computing devices.

Management platform 202 can receive physical identity information from computing device 220 via a wired or wireless network. For example, physical identity information can be transmitted from computing device 220 to management platform 202 through a wired connection (e.g., a wired local area network). As another example, physical identity information can be transmitted from computing device 220 to management platform 202 through a wireless network. A wireless network, as used herein, can include Wi-Fi, Bluetooth, or any other suitable means to wirelessly transmit information.

Management platform 202 can generate a digital identity corresponding to the physical identity of the user, as described in connection with FIG. 1. For instance, the management platform can generate a digital identity for use in a building with a physical access control system utilizing the physical identity information of the user.

Management platform 202 can simultaneously generate a physical badge corresponding to the physical identity of the user, as described in connection with FIG. 1. For instance, the management platform 202 can generate a physical badge for use in a building with a physical access control system utilizing the physical identity information of the user. Mobile device 224 can receive a digital identity from management platform 202 by way of a network 222. Mobile device 224 can be a phone (e.g., a smart phone), a tablet, a personal digital assistant (PDA), and/or a wrist-worn device, among other types of devices that may be carried and/or worn by a user.

Network 222 can be a network relationship that connects mobile device 224 to management platform 202. Examples of such a network relationship can include a local area network (LAN), wide area network (WAN), personal area network (PAN), a distributed computing environment (e.g., a cloud computing environment), and/or the Internet, among other types of network relationships that can connect mobile device 224 to management platform 202.

Although not pictured in FIG. 2, management platform 202 can share a number of digital identities with a building management system through network 222. For example, a building management system can receive a number of digital identities from management platform 202 through network 222. Further, a number of different building management systems can receive a digital identity from management platform 202 through network 222.

Further, although network 222 is described as connecting mobile device 222 and/or a building management system to management platform 202, embodiments of the present disclosure are not so limited. For example, network 222 can connect management platform 202 to other devices and/or systems.

FIG. 3 is a schematic block diagram of a management platform 302 for use with a digital identity enrollment system, in accordance with one or more embodiments of the present disclosure. For example, management platform 302 can include a memory 306 and a processor 304 configured to execute executable instructions stored in memory 306 to receive information verifying a user's physical identity, generate a digital identity corresponding to the physical identity of the user, generate a physical badge corresponding to the physical identity of the user, and send the digital identity to a mobile device of the user.

The memory 306 can be any type of storage medium that can be accessed by the processor 304 to perform various examples of the present disclosure. For example, the memory 306 can be a non-transitory computer readable medium having computer readable instructions (e.g., computer program instructions) stored thereon that are executable by the processor 304 to generate a physical badge and a digital identity and send the digital identity to a mobile device of a user in accordance with the present disclosure. That is, processor 304 can execute the executable instructions stored in memory 306 to generate a physical badge and a digital identity and send the digital identity to a mobile device of a user in accordance with the present disclosure.

The memory 306 can be volatile or nonvolatile memory. The memory 306 can also be removable (e.g., portable) memory, or non-removable (e.g., internal) memory. For example, the memory 306 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 306 is illustrated as being located within management platform 302, embodiments of the present disclosure are not so limited. For example, memory 306 can also be located internal to another computing resource (e.g., enabling computer readable instructions to be downloaded over the Internet or another wired or wireless connection).

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor. It is presumed that logic similarly executes instructions for purposes of the embodiments of the present disclosure.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A management platform for a digital identity enrollment system, comprising:
a memory; and
a processor configured to execute executable instructions stored in the memory to:
receive, from a computing device, information verifying a user's physical identity;
generate, by the management platform, a digital identity corresponding to the physical identity of the user;
send, by the management platform, the digital identity to a mobile device of the user; and
modify, by the management platform, physical identification information of the digital identity of the user.

2. The management platform of claim 1, wherein the processor is configured to execute the instructions to generate a physical badge corresponding to the physical identity of the user.

3. The management platform of claim 1, wherein the digital identity is unique to the mobile device of the user.

4. The management platform of claim 1, wherein the user's physical identity information includes one or more of:
a name of the user;
an age of the user;
physical characteristics of the user;
a date of birth of the user; or
a picture of the user.

5. The management platform of claim 1, wherein the digital identity further includes access information for a building.

6. The management platform of claim 5, wherein the access information is preconfigured access information.

7. The management platform of claim 6, wherein the access information is customized access information.

8. The management platform of claim 1, wherein the digital identity is one of a permanent or temporary digital identity.

9. A method for operating a digital identity enrollment system, comprising:
receiving, from a computing device by a management platform, information verifying a number of users' respective physical identities;
generating, by the management platform, a number of digital identities, wherein each respective digital identity corresponds to a different one of the number of physical identities;
generating, by the management platform, a number of physical badges, wherein each respective physical badge corresponds to a different one of the number of physical identities; and
sending, by the management platform, to a mobile device of each respective user, the digital identity corresponding to that user's physical identity; and
modifying, by the management platform, physical identification information of the digital identity of one of the respective users.

10. The method of claim 9, wherein generating the number of digital identities includes assigning the number of users' physical identification information to their respective digital identities.

11. The method of claim 9, wherein the method includes assigning access information to the number of digital identities.

12. The method of claim 9, wherein sending the digital identities to the mobile device of each respective user includes sending a request to download an identity application to the mobile device of each respective user.

13. The method of claim 12, wherein the digital identities are sent to the respective identity applications on the mobile devices of the respective users.

14. The method of claim 9, wherein each respective digital identity is unique to its respective mobile device.

15. (canceled)

16. The method of claim 9, wherein the method includes sending the modified digital identity to the mobile device of the respective user.

17. The method of claim 9, wherein the method includes revoking a digital identity.

18. A system for digital identity enrollment, comprising:
a computing device configured to receive information verifying a user's physical identity;
a management platform configured to:
generate a digital identity and a physical badge corresponding to the physical identity of the user; and
modify physical identification information of the digital identity of the user; and
a mobile device configured to receive the digital identity.

19. The system of claim 18, wherein the digital identity is shared with a building management system.

20. The system of claim 19, wherein the building management system monitors use of the digital identity in a building.
